(19) United States
(12) Patent Application Publication
(10) Pub. No.: US 2025/0373576 A1
(43) Pub. Date: Dec. 4, 2025

(54) GENERATING RESPONSES TO USER INPUT USING FACETS

(71) Applicant: Microsoft Technology Licensing, LLC, Redmond, WA (US)

(72) Inventors: Mingqi Shen, San Mateo, CA (US); Zane Tarafa Homsi, Vienna, VA (US); Anthony Tuan Anh Huynh, Dublin, CA (US); Chih Hui Wang, San Jose, CA (US); Mengdie Tu, Sunnyvale, CA (US)

(21) Appl. No.: 18/732,432

(22) Filed: Jun. 3, 2024

(51) Int. Cl. H04L 51/02

(52) U.S. Cl. CPC H04L 51/02

(57) ABSTRACT

Methods, systems, and apparatuses include receiving input, from a user of an online system, via a chat interface. A set of facets is determined for the input using data for the user. An embedding is generated for the input. Content item embeddings are retrieved. The content item embeddings are filtered using the determined set of facets. A set of relevant content items is determined using the input embedding and the filtered content item embeddings. A response prompt is generated using the input embedding and the set of relevant content items. A response is generated by applying a generative machine learning model to the response prompt. The generated response is sent to the user via the chat interface.

### TECHNICAL FIELD

The present disclosure generally relates to machine learning, and more specifically, relates to response generation approaches to machine learning.

### BACKGROUND ART

Machine learning is a category of artificial intelligence. In machine learning, a model is defined by a machine learning algorithm. A machine learning algorithm is a mathematical and/or logical expression of a relationship between inputs to and outputs of the machine learning model. The model is trained by applying the machine learning algorithm to input data. A trained model can be applied to new instances of input data to generate model output. Machine learning model output can include a prediction, a score, or an inference, in response to a new instance of input data. Application systems can use the output of trained machine learning models to determine downstream execution decisions, such as decisions regarding various user interface functionality.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a facet-based response generation component in accordance with some embodiments of the present disclosure.

FIG. 2 illustrates another example computing system that includes a facet-based response generation component in accordance with some embodiments of the present disclosure.

FIG. 2 illustrates another example computing system that includes a facet-based response generation component in accordance with some embodiments of the present disclosure.

FIG. 3 illustrates another example computing system that includes a facet-based response generation component in accordance with some embodiments of the present disclosure.

FIG. 4 illustrates an exemplary user interface in accordance with some embodiments of the present disclosure.

FIG. 5 is a flow diagram of an example method to generate responses to user input using content item embeddings labeled with facets in accordance with some embodiments of the present disclosure.

FIG. 6 is a flow diagram of an example method to generate responses to user input using content item embeddings labeled with facets in accordance with some embodiments of the present disclosure.

FIG. 7 is a flow diagram of an example method to generate responses to user input using content item embeddings labeled with facets in accordance with some embodiments of the present disclosure.

FIG. 8 is a flow diagram of an example method to generate responses to user input using content item embeddings labeled with facets in accordance with some embodiments of the present disclosure.

FIG. 9 is a block diagram of an example computer system in which embodiments of the present disclosure can operate.

### DETAILED DESCRIPTION

Machine learning-enabled response generation systems interact with users by processing input from the users and generating responses to that input. These systems can use generative artificial intelligence (GAI) to generate a response to a specific user input. Conventional systems have access to large and diverse databases in order to generate responses to a wide variety of diverse user input possibilities. As the databases accessible by these response generation systems grow, however, the amount of time it takes to generate responses using the databases increases, decreasing the overall throughput of the system. Accordingly, conventional response generation systems must balance the tradeoff of access to larger amounts of data with response generation processing time and throughput for the systems. Additionally, as the size and variety of content included in these databases increases, the probability that output of a GAI-enabled response generation system will include artificial intelligence hallucinations. An artificial intelligence hallucination is when a GAI system produces an output that is incorrect and/or inconsistent with reality. For example, a GAI system can generate an answer that is incorrect because it mixes inconsistent data sources. Response generation systems accessing different content categories with similar terminology (e.g., semantically similar) can mix the content in the response, generating responses that are not accurate for either content category.

The shortcomings of these conventional response generation systems are particularly acute when implemented in environments with many different content categories with semantically similar terms. Response generation systems that do not properly differentiate between different content categories can take significantly longer to generate the response (e.g., due to the larger amount of data relevant to the user input) and/or generate responses that provide incorrect information (e.g., hallucinations that mix content from different content item categories).

A response generation system using content item embeddings labeled with facets, as described herein includes a number of different components that alone or in combination address the above and other shortcomings of the conventional machine learning agent systems, particularly when applied to environments with large databases. For example, by labeling content items with facets based on tags of the content items, the response generation system can create a database including embeddings for the content items and relevant facets. The response generation can use data associated with user input (e.g., facets and/or intent of the user input) to filter the content item embeddings available when generating the response to the user input. Accordingly, the response generation system can respond more accurately to user inputs while reducing the response generation time, thereby increasing the throughput of the entire system. This effect is even more pronounced the more complicated the user input, allowing the response generation system to provide responses to complicated user input much faster than conventional systems. For example, the more complicated the user input, the larger the amount of databases and/or data that need to be searched, retrieved, and processed. By using facets to reduce the amount of data to search, retrieve, and process, the response generation system can provide responses to the user input in less time than conventional system.

Additionally, the response generation system can search and retrieve large pieces of content based on related chunks. This reduces the amount of time required to search and retrieve relevant content while retaining the quality of the response. For example, the response generation system breaks larger content items into chunks with metadata identifying the chunks' position and/or relation to the content item as a whole and the other chunks of that content item. The response generation system uses these smaller chunks (as opposed to the content item as a whole) while searching for relevant content. When the response generation system finds a relevant chunk, the system can then use the chunk metadata to retrieve related chunks and/or the content item as a whole and generate the response using the relevant chunk as well as the retrieved chunks and/or content item. This reduces the search and processing time since the response generation system only needs to compare smaller chunks but retains the quality of the response because the response generation system still uses the retrieved chunks and/or content item.

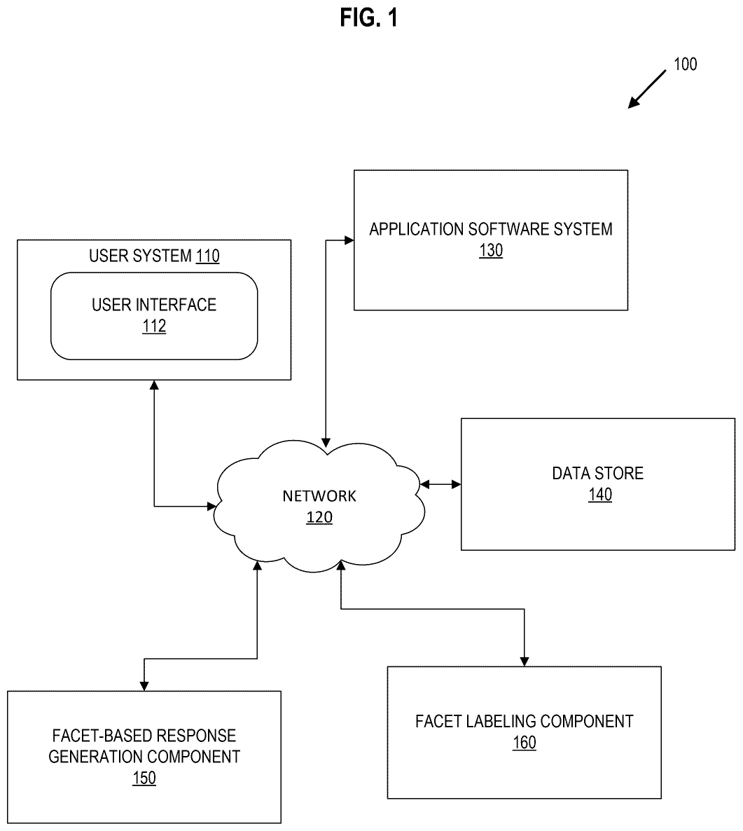

FIG. 1 illustrates an example computing system 100 that includes a facet-based response generation component 150 in accordance with some embodiments of the present disclosure. In the embodiment of FIG. 1, computing system 100 includes a user system 110, a network 120, an application software system 130, a data store 140, a facet-based response generation component 150, and a facet labeling component 160. Each of these components of computing system 100 are described in more detail below. In some embodiments, the components of computing system 100 and their respective subcomponent are implemented on one or more of user devices, cloud servers and/or databases, and combinations thereof.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 can be or include a front-end portion of application software system 130.

User interface 112 is any type of user interface as described above. User interface 112 can be used to interact with a chat interface and view or otherwise perceive output that includes data produced by application software system 130. For example, user interface 112 can include a graphical user interface and/or a conversational voice/speech interface that includes a mechanism for entering a queries to a chat interface and viewing chat query results and/or other digital content. Examples of user interface 112 include web browsers, command line interfaces, and mobile apps. User interface 112 as used herein can include application programming interfaces (APIs).

Network 120 can be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

Application software system 130 is any type of application software system that includes or utilizes functionality and/or outputs provided by facet-based response generation component 150 and/or facet labeling component 160. Examples of application software system 130 include but are not limited to online services including connections network software, such as social media platforms, and systems that are or are not be based on connections network software, such as general-purpose search engines, content distribution systems including media feeds, bulletin boards, and messaging systems, special purpose software such as but not limited to job search software, recruiter search software, sales assistance software, advertising software, learning and education software, enterprise systems, customer relationship management (CRM) systems, or any combination of any of the foregoing.

A client portion of application software system 130 can operate in user system 110, for example as a plugin or widget in a graphical user interface of a software application or as a web browser executing user interface 112. In an embodiment, a web browser can transmit an HTTP request over a network (e.g., the Internet) in response to user input that is received through a user interface provided by the web application and displayed through the web browser. A server running application software system 130 and/or a server portion of application software system 130 can receive the input, perform at least one operation using the input, and return output using an HTTP response that the web browser receives and processes.

While not specifically shown, it should be understood that any of user system 110, application software system 130, data store 140, facet-based response generation component 150, and facet labeling component 160 includes an interface embodied as computer programming code stored in computer memory that when executed causes a computing device to enable bidirectional communication with any other of user system 110, application software system 130, data store 140, facet-based response generation component 150, and facet labeling component 160 using a communicative coupling mechanism. Examples of communicative coupling mechanisms include network interfaces, inter-process communication (IPC) interfaces and application program interfaces (APIs).

Data store 140 can include any combination of different types of memory devices. Data store 140 stores digital data used by user system 110, application software system 130, facet-based response generation component 150, and/or facet labeling component 160. Data store 140 can reside on at least one persistent and/or volatile storage device that can reside within the same local network as at least one other device of computing system 100 and/or in a network that is remote relative to at least one other device of computing system 100. Thus, although depicted as being included in computing system 100, portions of data store 140 can be part of computing system 100 or accessed by computing system 100 over a network, such as network 120.

Each of user system 110, application software system 130, data store 140, facet-based response generation component 150, and facet labeling component 160 is implemented using at least one computing device that is communicatively coupled to electronic communications network 120. Any of user system 110, application software system 130, data store 140, facet-based response generation component 150, and facet labeling component 160 can be bidirectionally communicatively coupled by network 120. User system 110 as well as one or more different user systems (not shown) can be bidirectionally communicatively coupled to application software system 130.

A typical user of user system 110 can be an administrator or end user of application software system 130, facet-based response generation component 150, and/or facet labeling component 160. User system 110 is configured to communicate bidirectionally with any of application software system 130, data store 140, facet-based response generation component 150, and/or facet labeling component 160 over network 120.

The features and functionality of user system 110, application software system 130, data store 140, facet-based response generation component 150, and facet labeling component 160 are implemented using computer software, hardware, or software and hardware, and can include combinations of automated functionality, data structures, and digital data, which are represented schematically in the figures. User system 110, application software system 130, data store 140, facet-based response generation component 150, and facet labeling component 160 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner.

The facet-based response generation component 150 generates responses to user input using facets. For example, facet-based response generation component 150 uses facets to retrieve relevant content items and includes one or more generative machine learning models for generating a response based on the retrieved relevant content items. Further details with regard to the operations of facet-based response generation component 150 are described below.

The facet labeling component 160 filters and processes content items into content item embeddings and labels the content items with facets for faster indexing and retrieval. Further details with regard to the operations of facet labeling component 160 are described below.

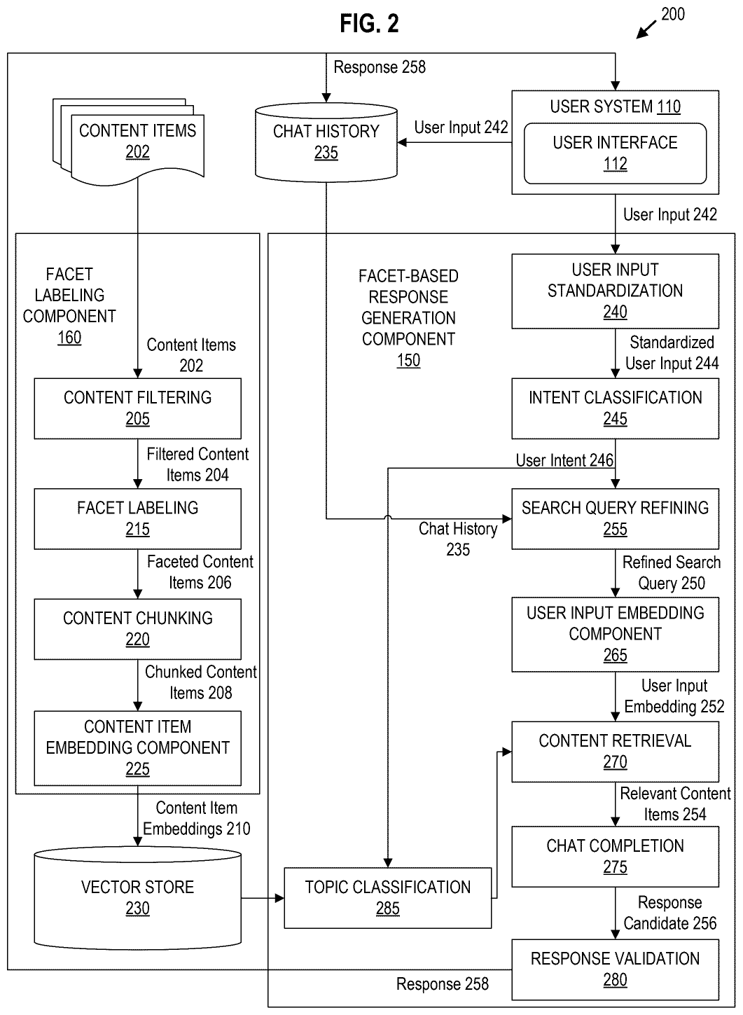

FIG. 2 illustrates another example computing system 200 that includes a facet-based response generation component 150 in accordance with some embodiments of the present disclosure. Example computing system 200 also includes user system 110, content items 202, chat history 235, facet labeling component 160, and vector store 230. In some embodiments, one or more of content items 202, chat history 235, and vector store 230 are implemented in a data store such as data store 140 of FIG. 1. As shown in FIG. 2, in some embodiments, facet labeling component 160 includes content filtering 205, facet labeling 215, content chunking 220, and content item embedding component 225. In some embodiments, facet-based response generation component 150 includes user input standardization 240, intent classification 245, search query refining 255, user input embedding component 265, content retrieval 270, topic classification 285, chat completion 275, and response validation 280. Each of these components will be described in more detail below.

In some embodiments, facet labeling component 160 receives or otherwise accesses content items 202. Content items 202 can include content stored in a data store (e.g., data store 140 of FIG. 1) accessible by facet labeling component 160. In some embodiments, content items 202 includes articles, documents, screenshots, videos, posts, etc. for use by a response generation component (e.g., facet-based response generation component 150) for generating a reply to user input. For example, content items 202 can include help articles for products available to a user of user system 110. In some embodiments, each content item of content items 202 includes metadata about the content item, which may be referred to as tags, examples of which could include identifiers that determine what is displayed on user interface 112. For example, content items may include a tag that indicates the content items relate to a specific augmentation of the end user experience.

In some embodiments, facet labeling component 160 generates the tags for content items 202. For example, facet labeling component 160 includes a machine learning model, such as an LLM, that assigns tags to each of content items 202 based on the content item itself. In some embodiments, facet labeling component 160 generates new tags. For example, facet labeling component 160 can include a machine learning model that uses clustering to determine shared attributes (e.g., semantically similar words, phrases, sentences, topics, etc.) and generates a new tag for content items of content items 202 that include those attributes.

Facet labeling component 160 retrieves content items 202 and filters content items 202 in content filtering 205. For example, content filtering 205 filters out content and/or content items from content items 202 that are unsuitable for generating responses to create filtered content items 204. Some examples of unsuitable content may include content that is legal in nature and/or content relating to self-harm. In some embodiments, content filtering 205 filters out content from content items 202 based on pre-defined rules. For example, content filtering 205 filters out content based on pre-defined criteria (e.g., words, phrases, images, etc.). Content filtering 205 sends filtered content items 204 to facet labeling 215. In some embodiments, content filtering 205 filters content items 202 using tags. For example, content filtering 205 filters out all content items of content items 202 based on tags associated with legal content.

Facet labeling 215 receives filtered content items 204 and processes filtered content items 204 to create faceted content items 206. For example, facet labeling 215 assigns facets to each content item in filtered content items 204. In some embodiments, facet labeling 215 assigns facets to each content item based on the tags for that content item. For example, facet labeling 215 assigns facets to a content item based on the product the content item relates to, topics the content item relates to, access levels the content item is associated with, account type the content item is associated with, etc. For example, a content item that is a help article for a product can include facets identifying the product to which the help article relates, topics addressed by the help article, and/or access levels associated with the help article. In some embodiments, singular content items of faceted content items 206 can include multiple facets. For example, a help article can include facets identifying the product to which it relates, the topics which it discusses, and an access level associated with that help article. In one embodiment, facet labeling 215 sends faceted content items 206 to content chunking 220.

Content chunking 220 receives faceted content items 206 and generates chunks for content items of faceted content items 206. For example, content chunking 220 chunks content items of faceted content items 206 into smaller pieces for faster use in downstream comparison and retrieval. In some embodiments, content chunking 220 determines to chunk content items based on a chunk size. For example, a chunk size is 1000 tokens and content chunking 220 chunks any content items of faceted content items 206 into chunks of 1000 tokens or less. In some embodiments, the chunk size is predetermined. For example, the chunk size is set to 1000 tokens and/or a chunk size associated with a sentence. In some embodiments, facet labeling component 160 determines the chunk size using the character size and/or content token size for the content item. In some embodiments, facet labeling component 160 determines the chunk size based on semantics of the content item and/or chunks. For example, facet labeling component 160 determines the chunk size such that each of the chunks retains its own semantic meaning. Content chunking 220 assigns chunk metadata to chunks generated from a single content item. For example, content chunking 220 assigns metadata about which content item each chunk relates to and its relative position to other chunks and the content item as a whole (e.g., metadata identifying previous and subsequent chunks).

In some embodiments, content chunking 220 determines one or more intents for a content item and chunks the content item based on the determined intents. For example, content chunking 220 determines that a single help article includes portions relating to different intents (e.g., topics) and determines chunks for that help article based on the portions that relate to the different intents. In some embodiments, content chunking 220 determines the different intents based on tags for the content item.

In some embodiments, each of the chunks for a content item in chunked content items 208 includes one or more facets for the content item to which it belongs. In other embodiments, facet labeling 215 assigns one or more facets to each chunk based on the tags and/or content for that chunk irrespective of the content item as a whole and/or the other chunks associated with that content item. Content chunking 220 sends chunked content items 208 to content item embedding component 225.

Content item embedding component 225 receives chunked content items 208 and generates content item embeddings 210 using chunked content items 208. For example, content item embedding component 225 receives chunked content items 208 and generates an embedding for each of chunked content items 208. In some embodiments, content item embedding component 225 generates content item embeddings 210 using a machine learning model. For example, content item embedding component 225 uses an embedding model to generate a numerical vector corresponding to chunked content item. This numerical vector can represent, for example, the semantics of the chunked content item. In such an example, embeddings for semantically similar content have a shorter distance in the representative vector space than embeddings for semantically different content. In some embodiments, content item embedding component 225 generates an embedding for each chunk of a content item of chunked content items 208.

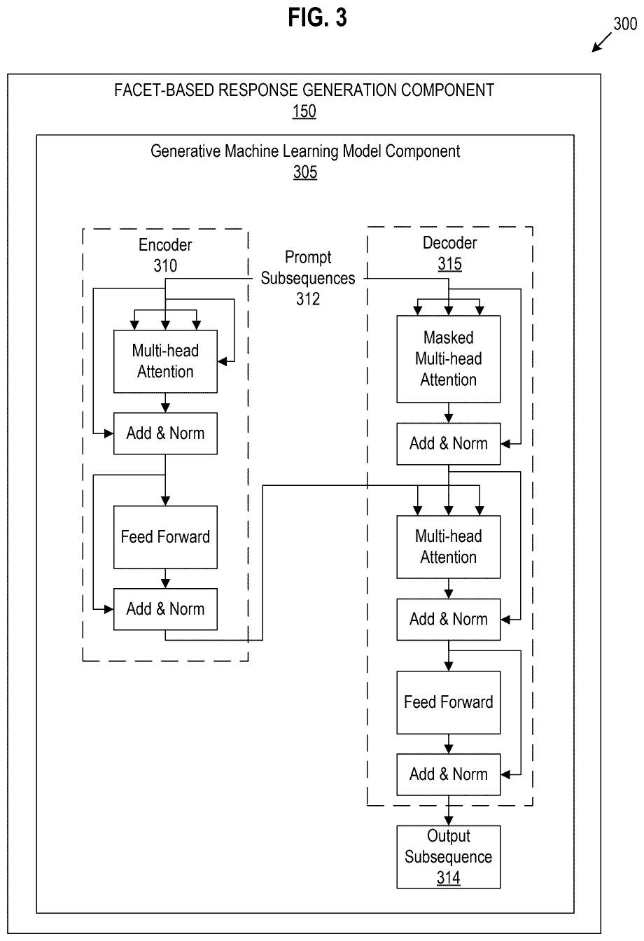

In some embodiments, content item embedding component 225 generates content item embeddings 210 from chunked content items 208 using a generative machine learning model (e.g., generative machine learning model component 305 of FIG. 3). For example, content item embedding component 225 creates a prompt instructing a machine learning model to generate an embedding for a content item of chunked content items 208. Content item embedding component 225 applies the generated prompt to the generative machine learning model causing the generative machine learning model to generate a content item embedding for that content item.

Content item embedding component 225 sends content item embeddings 210 to vector store 230 for storage and future retrieval. For example, vector store 230 belongs to a data store (e.g., data store 140 of FIG. 1) which stores content item embeddings 210 for future access and retrieval. In some embodiments, content item embeddings 210 includes the facets determined by facet labeling 215. For example, a content item embedding of content item embeddings 210 is stored with the vector generated by content item embedding component 225 as well as the facet data generated by facet labeling 215. In such embodiments, content item embeddings of content item embeddings 210 can be easily retrieved based on their associated facets. Further details regarding retrieving content item embeddings 210 are discussed below.

As shown in FIG. 2, facet-based response generation component 150 receives user input 242 from user system 110. In some embodiments, a user of user system 110 interacts with user interface 112, causing user system 110 to send user input 242 to facet-based response generation component 150. For example, a user of user system 110 inputs content into a chat interface of user interface 112. User system 110 receives this input content and generates user input 242 based on the input content. In some embodiments, user input 242 includes the input content as well as other data about the user of user system 110. For example, user input 242 includes data about the products that the user is subscribed to, the access level of the user, and historical usage for that user.

In some embodiments, facet-based response generation component 150 retrieves the data in response to receiving user input 242. For example, user input 242 includes an identifier for the user of user system 110 and facet-based response generation component 150 retrieves data for that user from a data store (e.g., data store 140 of FIG. 1) in response to receiving user input 242.

User input standardization 240 receives user input 242 from user system 110 and processes user input 242 into standardized user input 244. For example, user input standardization 240 processes user input 242 into a standardized search query format (e.g., how to). In some embodiments, user input standardization 240 generates standardized user input 244 including a prompt for a machine learning model. For example, user input standardization 240 generates a prompt (e.g., standardized user input 244) for user input 242 including instructions to generate a standardized search query for user input 242. In some embodiments, user input standardization 240 processes user input 242 into a standardized format using metadata of user input 242. For example, user input standardization 240 generates a prompt for user input 242 with instructions that are based on the metadata associated with user input 242. In one embodiment, user input standardization 240 generates standardized user input 244 including a prompt with instructions based on a product the user of user system 110 is subscribed to. Accordingly, the downstream machine learning model can generate a response to user input 242 that is specific to a product to which the user of user system 110 is subscribed. For example, user input standardization 240 can identify that the user input is searching for help content and includes instructions in prompt for user input 242 to explicitly search for help content, thereby improving the search accuracy. User input standardization 240 sends standardized user input 244 to intent classification 245.

Intent classification 245 receives standardized user input 244 and generates user intent 246. For example, intent classification 245 classifies the intent of standardized user input 244. The intent can include, for example, whether the user input includes a desire to speak with an agent, whether the user input includes a greeting, whether the user input includes a prompt injection, whether the user input is requesting help, etc. In some embodiments, intent classification 245 generates user intent 246 using user input 242. In some embodiments, intent classification 245 generates user intent 246 using standardized user input 244. In some embodiments, intent classification 245 generates user intent 246 using metadata of user input 242 and/or standardized user input 244. For example, the metadata of user input 242 and/or standardized user input 244 includes historical data indicating that the user has recently performed a search for how to address an account problem. In such an example, intent classification 245 can determine a user intent 246 for help based on this historical data. Intent classification 245 sends user intent 246 to search query refining 255.

Search query refining 255 receives user intent 246 and generates refined search query 250 using user intent 246 and standardized user input 244. For example, search query refining 255 generates refined search query 250 including a prompt including the prompt generated by user input standardization 240 (e.g., standardized user input 244) and the user intent 246 determined by intent classification 245.

In some embodiments, search query refining 255 receives chat history 235. For example, chat history 235 includes data about previous interactions between the user or the user system 110 and facet-based response generation component 150. Chat history 235 can include, for example, previous requests (e.g., user inputs) sent by the user or the user system 110 and responses to those previous requests sent by facet-based response generation component 150. In such embodiments, search query refining 255 generates refined search query 250 based on the context provided by chat history 235. For example, refined search query 250 can include a prompt with a statement indicating previous unsuccessful responses and/or previous information provided by user system 110. Search query refining 255 sends refined search query 250 to user input embedding component 265.

User input embedding component 265 receives refined search query 250 and generates user input embedding 252 using refined search query 250. In some embodiments, user input embedding component 265 generates user input embedding 252 using a machine learning model. For example, user input embedding component 265 uses an embedding model to generate a numerical vector corresponding to refined search query 250. As explained above, this numerical vector can represent, for example, the semantics of the refined search query. In some embodiments, user input embedding component 265 generates user input embedding 252 from refined search query 250 using a generative machine learning model (e.g., generative machine learning model component 305 of FIG. 3). For example, user input embedding component 265 creates a prompt instructing a machine learning model to generate an embedding for refined search query 250. User input embedding component 265 applies the generated prompt to the generative machine learning model causing the generative machine learning model to generate user input embedding 252. User input embedding component 265 sends user input embedding 252 to content retrieval 270.

Content retrieval 270 retrieves relevant content items 254 using user input embedding 252. For example, content retrieval 270 performs a similarity search between the content item embeddings 210 of vector store 230 and user input embedding 252 and retrieves relevant content items 254 based on the content item embeddings with a high degree of similarity to user input embedding 252. In some embodiments, content retrieval 270 determines relevant content items 254 as the content items with embeddings that have the highest similarity to user input embedding 252. For example, content retrieval 270 determines relevant content items 254 and the content items with embeddings that are the top ten most similar (e.g., shortest distance in the vector space of user input embedding 252 and content item embeddings 210) to user input embedding 252. In some embodiments content retrieval 270 determines relevant content items 254 based on a similarity threshold. For example, content retrieval 270 determines relevant content items 254 using embeddings with similarity search results that satisfy a similarity threshold (e.g., a certain distance in the vector space and/or a certain percent similarity). In some embodiments, content retrieval 270 performs a similarity search using a cosine similarity search.

In some embodiments, topic classification 285 determines relevant content items 254 of content item embeddings 210 using facet-based exclusion. For example, topic classification 285 determines facets for user input 242. In some embodiments, topic classification 285 determines the facets based on metadata of user input 242. For example, topic classification 285 determines the facets based on products to which the user of user system 110 is subscribed and/or an access level for the user of user system 110. In such embodiments, topic classification 285 can determine a set of content items embeddings to use from content item embeddings 210 stored in vector store 230 based on these determined facets. For example, topic classification 285 can exclude all content items that do not have facets that match the determined facets for user input 242.

In some embodiments, topic classification 285 determines facets for user input 242 using a machine learning model. For example, topic classification 285 applies an LLM to user input 242 to determine facets for user input 242. Content retrieval 270 performs the similarity search on content item embeddings based on the determined facets. For example, content retrieval 270 only performs a similarity search on content item embeddings of content item embeddings 210 with facets that are shared with the determined facets for user input 242. Because performing the similarity search can be a computationally intensive task, computing system 200 saves resources such as computing power and time by only performing the similarity search on a subset of content item embeddings 210. Accordingly, the total throughput of computing system 200 is improved as a result of using this facet-based exclusion.

In some embodiments, topic classification 285 determines facets of user input 242 using user intent 246. For example, user intent 246 indicates a help intent (e.g., a user is seeking help with a problem). In such an example, topic classification 285 uses this help intent and the products to which the user of user system 110 is subscribed to determine facets for user input 242. Such facets can include topics relating to the matter to which the user is seeking help and the product to which the user is subscribed.

In some embodiments content retrieval 270 retrieves content items using chunks. For example, content retrieval 270 performs a similarity search and determines that a content item embedding corresponding with a content item chunk satisfies the similarity threshold. In such an embodiment, content retrieval 270 retrieves additional content item chunks using the metadata of the content item chunk that satisfies the similarity threshold. For example, content retrieval 270 can retrieve nearby chunks of the content item (e.g., using positional metadata). As an alternate example, content retrieval 270 can retrieve related chunks of the content item (e.g., using semantic metadata regardless of the position of the chunks). In some embodiments, content retrieval 270 retrieves the entirety of the content item.

As mentioned above, performing a similarity search can be a resource intensive task. Since content item embeddings are stored in chunks in vector store 230 (e.g., smaller portions of the whole content item), content retrieval 270 can more quickly determine similarity between user input embedding 252 and a chunk of a content item than if the content item embedding were stored in its entirety. In response to determining that a chunk of a content item is relevant (e.g., satisfies the similarity threshold), content retrieval 270 can then retrieve the other chunks of the content item using the metadata without the need to perform a resource intensive similarity search on the content item as a whole. Accordingly, by using chunked content item embeddings, computing system 200 saves computing power and time and increases the throughput of the system as a whole. Content retrieval 270 sends relevant content items 254 to chat completion 275.

Chat completion 275 generates a response prompt using user input embedding 252 and relevant content items 254. For example, chat completion 275 generates a prompt instructing a machine learning model to generate a response to user input 242 represented by user input embedding 252 using resources from relevant content items 254. By providing only relevant content items 254 (e.g., based on facet-based exclusion and similarity search), computing system 200 can prevent hallucination in the response generated by the machine learning model. For example, because content items can include semantically similar material for different products, a system that does not use facet-based exclusion could generate a response to mixes instructions for multiple products, creating a response to does not address the problems for users of either product (or only addresses the problems for a single product). By using facet-based exclusion (e.g., based on metadata associated with the user of user system 110), computing system 200 can restrict the content items consulted when generating response candidate 256 forcing the machine learning model to only rely upon relevant data and thereby preventing hallucination.

In some embodiments, chat completion 275 generates a response prompt including guidance on style and format. For example, chat completion 275 can determine guidance to include in the response prompt based on metadata of user input 242. In some embodiments, chat completion 275 generates a prompt including specific rules (e.g., do not include a uniform resource locator (URL) in response candidate 256). In some embodiments, the generative machine learning model is finetuned based on example responses. For example, instead of providing guidance on style and format and/or rules in the response prompt, the generative machine learning model is trained using example responses and generates response candidate 256 according to the example responses.

Chat completion 275 applies a machine learning model (e.g., generative machine learning model component 305 of FIG. 3) to the generated response prompt, causing the machine learning model to generate response candidate 256. For example, chat completion 275 sends the response prompt to a generative machine learning model which generates response candidate 256 based on the response prompt (e.g., a response to user input 242 based on accessing relevant content items 254). In some embodiments, the generative machine learning model is provided access to relevant content items 254 but only uses a subset of relevant content items 254 in generating response candidate 256. Chat completion 275 sends response candidate 256 to response validation 280.

Response validation 280 receives response candidate 256 and determines whether to send response candidate 256 as response 258. For example, response validation 280 checks for hallucinations and/or inappropriate content (e.g., responses including profanity, legal content, and/or prejudicial content) and sends response 258 in response to successfully validating response candidate 256. In some embodiments, response validation 280 determines whether to send response candidate 256 as response 258 using a machine learning model. For example, response validation 280 generates a prompt for a generative machine learning model to determine whether response candidate 256 includes hallucinations and/or inappropriate content. Facet-based response generation component 150 sends response 258 to user system 110. For example, facet-based response generation component 150 sends response 258 to user system 110 via a chat interface of user interface 112, causing user interface 112 to display response 258. In some embodiments, response validation 280 stores response 258 in chat history 235 for future access.

In some embodiments, facet-based response generation component 150 sends response 258 as multiple response subdivisions. For example, facet-based response generation component 150 divides response 258 into subdivisions and response validation 280 validates each of the subdivisions of response 258 before sending the subdivision to user system 110. By breaking response 258 into subdivisions, facet-based response generation component 150 can stream response 258 to user system 110 somewhat continuously rather than waiting for the entirety of response 258 to be generated and/or validated. For example, chat completion 275 generates response 258 in a streaming manner rather than all at once. Accordingly, as response validation 280 receives the stream of response 258, response validation breaks the stream into subdivisions and validates each subdivision before sending to user system 110 as opposed to waiting for the entirety of response 258 to be generated and sending at one time. In some embodiments, response validation 280 determines the subdivisions based on a set length (e.g., every sentence).

FIG. 3 illustrates another example computing system 300 that includes a facet-based response generation component in accordance with some embodiments of the present disclosure. As shown in FIG. 3, facet-based response generation component 150 includes a generative machine learning model component 305.

In some embodiments, the generative machine learning model component 305 is constructed using a neural network-based machine learning model architecture. In some embodiments, the neural network-based architecture includes one or more self-attention layers (e.g., multi-head attention layers and masked multi-head attention layers) that allow the model to assign different weights to different features included in the model input. Alternatively, or in addition, the neural network architecture includes feed-forward layers and residual connections (e.g., add & norm layers) that allow the model to machine-learn complex data patterns including relationships between different inputs and outputs in multiple different contexts. In some embodiments, generative machine learning model component 305 is constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation of the response generation system.

As shown in FIG. 3, generative machine learning model component 305 feeds prompt subsequences 312 into encoder 310 and decoder 315. For example, generative machine learning model component 305 feeds the inputs of prompt subsequences into the multi-head attention layer of encoder 310. In some embodiments, the inputs of prompt subsequences 312 are a series of tokens and the output of the encoder. Generative machine learning model component 305 feeds the output of encoder 310 and outputs of prompt subsequences 312 into decoder 315 which generates a sequence of tokens based on the output of encoder 310 and the inputs of prompt subsequences 312. While a specific architecture of encoder 310 and decoder 315 is shown for simplicity, as explained above, the exact number and arrangement of layers of each type as well as the hyperparameter values used to configure the model are determined based on the requirements of a particular design or implementation. Generative machine learning model component 305 can therefore include different numbers, arrangements, and types of layers, such that each input of prompt subsequences 312 are fed through the layers of generative machine learning model component 305 and is dependent on other input tokens of prompt subsequences 312.

As mentioned above, generative machine learning model component 305 illustrates a generic encoder/decoder model for simplicity. In such a model, encoder 310 encodes the input into a fixed-length vector and decoder 315 decodes the fixed-length vector into output subsequence 314. Encoder 310 and decoder 315 are trained together to maximize the conditional log-likelihood of the output given the input. For example, once trained, encoder 310 and decoder 315 can generate an output given an input sequence or can score a pair of input/output sequences based on their probability of coexistence.

In some embodiments, generative machine learning model component 305 can train and/or execute one or more encoder/decoder pairs to generate a response based on an input prompt. In some embodiments, generative machine learning model component 305 is implemented by chat completion 275 of FIG. 2. For example, generative machine learning model component 305 generates response candidate 256 from a prompt and relevant content items 254. In some embodiments, generative machine learning model component 305 is implemented by user input embedding component 265 of FIG. 2. For example, generative machine learning model component 305 generates user input embedding 252 from refined search query 250 based on a prompt. In some embodiments, generative machine learning model component 305 is implemented by content item embedding component 225 of FIG. 2. For example, generative machine learning model component 305 generates content item embeddings 210 from chunked content items 208 based on a prompt.

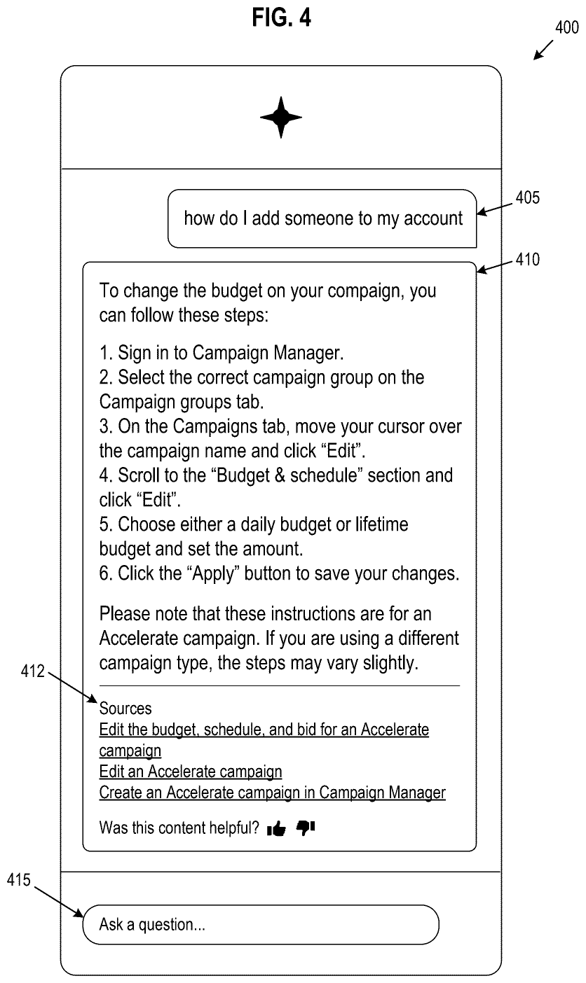

FIG. 4 illustrates an exemplary user interface 400 in accordance with some embodiments of the present disclosure. As shown in FIG. 4, user interface 400 includes user input 405, response 410, sources 412, and user input interface 415.

In some embodiments, user interface 400 is implemented on the user interface of a response generation system (e.g., user interface 112 of FIGS. 1 and 2). In response to a user interacting with user input interface 415 and inputting user input 405, the response generation system (e.g., computing system 300 of FIG. 3) determines facets for the user of the user interface and generates response 410. For example, the facets include the kind of product that the user is subscribed to. Accordingly, the response 410 generated and displayed in user interface 400 includes information generated for that specific product. In some embodiments, as shown in FIG. 4, sources 412 is a list of sources included in generated response 410. For example, response 410 includes a list of and/or links to one or more of the relevant content items (e.g., relevant content items 254) used to generate response 410.

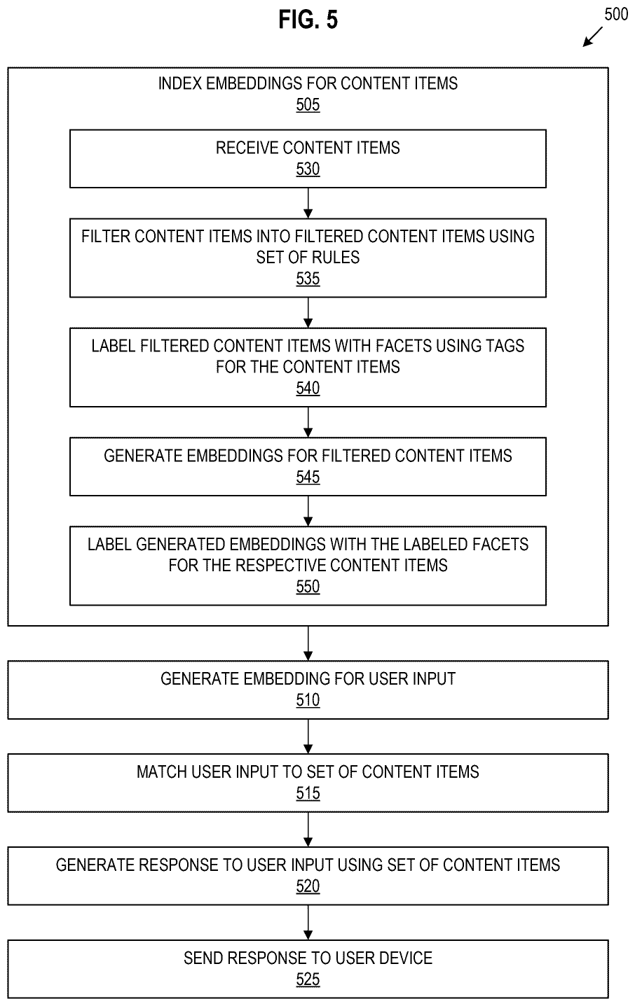

FIG. 5 is a flow diagram of an example method 500 to generate responses to user input using content item embeddings labeled with facets in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by facet-based response generation component 150 of FIG. 1. In other embodiments, the method 500 is performed by facet labeling component 160 of FIG. 1. In still other embodiments, parts of the method 500 are performed by facet-based response generation component 150 and parts of the method 500 are performed by facet labeling component 160. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 505, the processing device indexes embeddings for content items. For example, facet labeling component 160 generates content item embeddings 210 from content items 202. In some embodiments, the processing device determines facets for the content items. For example, facet labeling component 160 determines facets for content items 202 (and/or filtered content items 204) using tags associated with each of the content items. In some embodiments, the processing device generates chunks for a content item. For example, content chunking 220 generates multiple chunks for a content item with metadata indicating their position in the content item. Further details regarding indexing embeddings for content items are discussed with reference to FIG. 2.

At operation 510, the processing device generates an embedding for user input. For example, facet labeling component 160 generates user input embedding 252 from user input 242. In some embodiments, the processing device generates the user input embedding by standardizing the user input. For example, facet labeling component 160 generates standardized user input 244 using metadata of user input 242. Further details regarding generating an embedding for user input are discussed with reference to FIGS. 2 and 4.

At operation 515, the processing device matches user input embedding to a set of content items. For example, facet labeling component 160 determines relevant content items 254 by performing a similarity search using user input embedding 252 and content item embeddings 210. In some embodiments, the processing device uses facet-based exclusion to determine a set of content item embeddings in addition to performing the similarity search. For example, facet labeling component 160 determines facets for user input 242 and generates relevant content items 254 by performing a similarity search on content item embeddings 210 with facets that match user input 242. Further details regarding matching user input to a set of content items are discussed with reference to FIGS. 2 and 5.

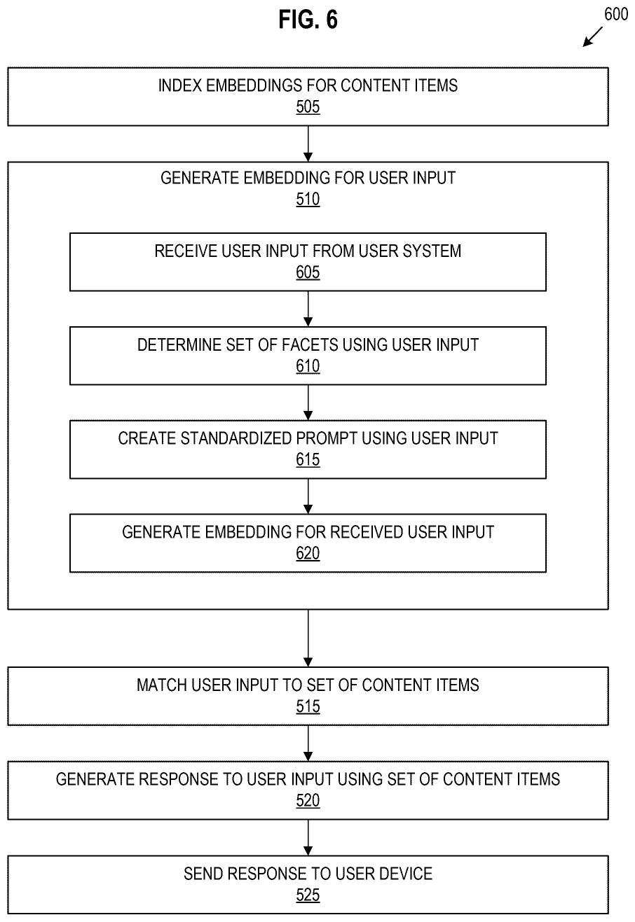

At operation 520, the processing device generates a response to the user input using the set of content items. For example, facet labeling component 160 generates a response prompt using user input embedding 252 and relevant content items 254. Facet labeling component 160 applies the response prompt to a generative machine learning model to generate response 258 using relevant content items 254. Further details regarding generating a response to the user input using the set of content items are discussed with reference to FIGS. 2 and 6.

At operation 525, the processing device sends the response to a user device. For example, facet labeling component 160 sends response 258 to user system 110 through a chat interface (e.g., via chat interface in user interface 112). In some embodiments, the processing device stores response 258 in chat history 235.

At operation 530, the processing device receives content items. For example, facet-based response generation component 150 receives content items 202 from a data store (such as data store 140 of FIG. 1). In some embodiments, each of the content items is associated with one or more tags. In some embodiments, the processing device receives content items from external websites. For example, the processing device receives at least some of content items 202 from external websites via an application programming interface (API). In some embodiments, content items 202 include tags based on their source. For example, content items from a data store include a first set of tags and content items from external websites include a second set of tags. Further details regarding receiving content items are discussed with reference to FIG. 2.

At operation 535, the processing device filters content items into filtered content items using set of rules. For example, content filtering 205 generates filtered content items 204 from content items 202 based on a set of rules. In some embodiments, the set of rules is predetermined based on suitable topics for chat interface. For example, the set of rules filters out content items from content items 202 that include legal language. In some embodiments, the processing device receives content items that are already filtered based on the set of rules. Further details regarding filtering content items into filtered content items are discussed with reference to FIG. 2.

At operation 540, the processing device labels filtered content items with facets using tags for the content items. For example, facet labeling component 160 labels filtered content items 204 based on the tags for those content items. In some embodiments, the processing device assigns facets to a content item based on one or more of: the product the content item relates to, topics the content item relates to, access levels the content item is associated with, account type the content item is associated with, etc. Further details regarding labeling filtered content items with facets are discussed with reference to FIG. 2.

At operation 545, the processing device generates embeddings for filtered content items. For example, content item embedding component 225 generates embeddings for each content item including a vector representing the content item in a vector space. In some embodiments, the processing device generates a prompt instructing a machine learning to generate embeddings based on the content items and applies the generative machine learning model to the prompt causing the generative machine learning model to generate the content item embeddings. In some embodiments, the processing device stores the content items in a vector store (e.g., vector store 230 of FIG. 2). Further details regarding generating embeddings for filtered content items are discussed with reference to FIG. 2.

At operation 550, the processing device generates embeddings with the labeled facets for the respective content items. For example, facet labeling component 160 stores content item embeddings 210 in vector store 230 along with the facets determined based on the tags associated with the content items. Further details regarding generating embeddings with the labeled facets are discussed with reference to FIG. 2.

FIG. 6 is a flow diagram of an example method 600 to generate responses to user input using content item embeddings labeled with facets in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by facet-based response generation component 150 of FIG. 1. In other embodiments, the method 600 is performed by facet labeling component 160 of FIG. 1. In still other embodiments, parts of the method 600 are performed by facet-based response generation component 150 and parts of the method 600 are performed by facet labeling component 160. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 605, the processing device receives user input from a user system. For example, facet-based response generation component 150 receives user input 242 from user system 110 in response to a user of user system 110 interacting with a chat interface such as user interface 112. In some embodiments, the user input include metadata, such as data about the user of the user system. For example, user input 242 includes data from a profile of a user of user system 110. Further details regarding receiving user input from a user system are discussed with reference to FIG. 2.

At operation 610, the processing device determines a set of facets using the user input. For example, facet-based response generation component 150 determines a set of facets for user input 242 based on the content of user input 242. In some embodiments, facet-based response generation component 150 determines the set of facets based on metadata of user input 242. For example, facet-based response generation component 150 determines the set of facets based on data taken from the profile of the user of user system 110 such as products that the user is subscribed to. Further details regarding determining a set of facets using the user input are discussed with reference to FIG. 2.

At operation 615, the processing device creates a standardized prompt using the user input. For example, facet-based response generation component 150 creates a prompt including the user input (e.g., text) from the user interacting with user interface 112. In some embodiments, the processing device creates the standardized prompt based on the metadata from the user input. For example, facet-based response generation component 150 uses a different prompt based on the products that the user of user system 110 is subscribed to. Further details regarding creating a standardized prompt using the user input are discussed with reference to FIG. 2.

At operation 620, the processing device generates embeddings for received user input. For example, facet-based response generation component 150 generates user input embedding 252 based at least on user input 242. In some embodiments, the processing device generates a prompt instructing a generative machine learning model to generate an embedding for the user input and applies the prompt to the generative machine learning model causing the generative machine learning model to generate the embedding for the user input. Further details regarding generating embeddings for the received user input are discussed with reference to FIG. 2.

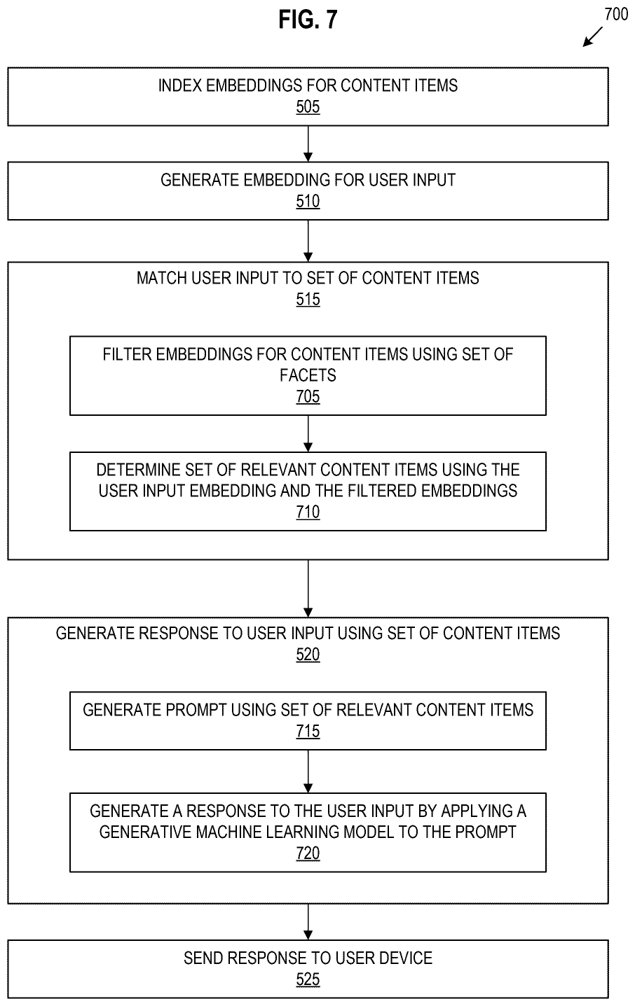

FIG. 7 is a flow diagram of an example method 700 to generate responses to user input using content item embeddings labeled with facets in accordance with some embodiments of the present disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by facet-based response generation component 150 of FIG. 1. In other embodiments, the method 700 is performed by facet labeling component 160 of FIG. 1. In still other embodiments, parts of the method 700 are performed by facet-based response generation component 150 and parts of the method 700 are performed by facet labeling component 160. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 705, the processing device filters embeddings for content items using the set of facets. For example, facet-based response generation component 150 filters content item embeddings 210 of vector store 230 based on whether the facets associated with the content item embeddings match the set of facets for the user input. In some embodiments, the processing device only retrieves content item embeddings with facets that match the set of facets for the user input. Further details regarding filtering embeddings for content items are discussed with reference to FIG. 2.

At operation 710, the processing device determines a set of relevant content items using the user input embedding and the filtered embeddings. For example, facet-based response generation component 150 performs a similarity search using the filtered content item embeddings and the user input embedding. In some embodiments, the processing device determines the set of relevant content items as the content items with content item embeddings that are most similar to the user input embedding based on the similarity search. For example, facet-based response generation component 150 determines relevant content items 254 as the content items with embeddings that are closest in the vector space to user input embedding 252. Further details regarding determining a set of relevant content items are discussed with reference to FIG. 2.

At operation 715, the processing device generates a prompt using the set of relevant content items. For example, facet-based response generation component 150 generates a prompt including user input embedding 252 and relevant content items 254. In some embodiments, the prompt instructing a generative machine learning model to generate a response to the user input represented by the user input embeddings by accessing the content from the relevant content items. Further details regarding generating a prompt using the set of relevant content items are discussed with reference to FIG. 2.

At operation 720, the processing device generates a response to the user input by applying a generative machine learning model to the prompt. For example, facet-based response generation component 150 applies a generative machine learning model to the prompt causing the generative machine learning model to generate response 258. Further details regarding generating a response to the user input are discussed with reference to FIG. 2.

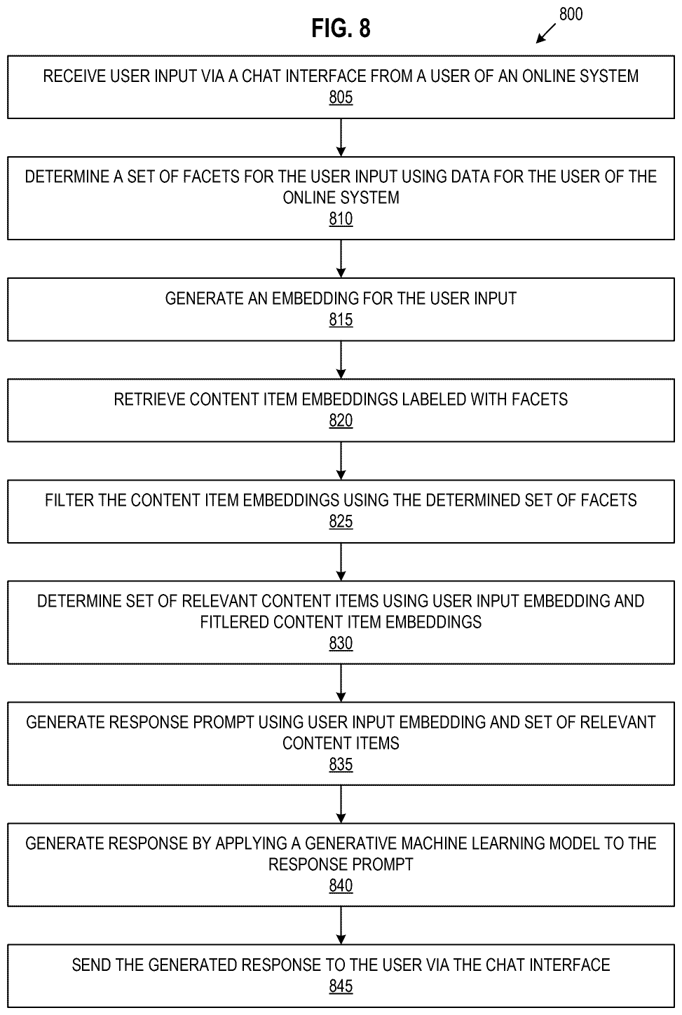

FIG. 8 is a flow diagram of an example method 800 to generate responses to user input using content item embeddings labeled with facets, in accordance with some embodiments of the present disclosure. The method 800 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 800 is performed by facet-based response generation component 150 of FIG. 1. In some embodiments, parts of the method 800 are performed by facet-based response generation component 150 and parts of the method 800 are performed by facet labeling component 160 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 805, the processing device receives user input via a chat interface from a user of an online system. For example, facet-based response generation component 150 receives user input 242 from user system 110 in response to a user of user system 110 interacting with user interface 112. Further details regarding receiving user input via a chat interface are discussed with reference to FIGS. 2 and 4.

At operation 810, the processing device determined a set of facets for the user input using data for the user of the online system. For example, facet-based response generation component 150 determines a set of facets for user input 242 based on metadata included in user input 242. In some embodiments, facet-based response generation component 150 retrieves the data in response to receiving user input 242. For example, user input 242 includes an identifier for the user of user system 110 and facet-based response generation component 150 retrieves data for that user from a data store (e.g., data store 140 of FIG. 1) in response to receiving user input 242. Further details regarding determining a set of facets for the user input are discussed with reference to FIGS. 2 and 4.

At operation 815, the processing device generates an embedding for the user input. For example, facet-based response generation component 150 generates an embedding for user input 242. In some embodiments, facet-based response generation component 150 uses metadata included in the user input to generate the user input embedding. Further details regarding generating an embedding for the user input are discussed with reference to FIGS. 2 and 3.

At operation 820, the processing device retrieves content item embeddings labeled with facets. For example, facet-based response generation component 150 retrieves content item embeddings 210 from vector store 230. Further details regarding retrieving content item embeddings are discussed with reference to FIGS. 2 and 5.

At operation 825, the processing device filters the content item embeddings using the determined set of facets. For example, facet-based response generation component 150 filters content item embeddings 210 based on the facets included in each of the content item embeddings of content item embeddings 210 and the determined set of facets for the user input. In some embodiments, the processing device filters out content item embeddings that do not share facets with the determined set of facets for the user input. Further details regarding filtering the content item embeddings are discussed with reference to FIGS. 2 and 5.

At operation 830, the processing device determines a set of relevant content items using the user input embedding and the filtered content item embeddings. For example, facet-based response generation component 150 performs a similarity search using the user input embedding and the set of relevant content items. In some embodiments, the processing device determines relevant content items based on the results of the similarity search satisfying a similarity threshold. In some embodiments, the processing device determined relevant content items as the content items with the highest similarity to the user input embeddings (e.g., top ten most similar content items). Further details regarding determining a set of relevant content items are discussed with reference to FIGS. 2 and 5.

At operation 835, the processing device generates a response prompt using the user input embedding and the set of relevant content items. For example, facet-based response generation component 150 generates a response prompt instructing a generative machine learning model to response to the user input identified by user input embedding 252. In such an example, the response prompt can include links to the set of relevant content items for the generative machine learning model to reference while generating the response. Further details regarding generating a response prompt are discussed with reference to FIGS. 2 and 5.

At operation 840, the processing device generates a response by applying the generative machine learning model to the response prompt. For example, facet-based response generation component 150 applies a generative machine learning model to the generated response prompt causing the generative machine learning model to generate response 258 responding to user input 242 using relevant content items 254. Further details regarding generating a response by applying the generative machine learning model to the response prompt are discussed with reference to FIGS. 2 and 5.

At operation 845, the processing device sends the generated response to the user via the chat interface. For example, facet-based response generation component 150 sends response 258 to user system 110 causing user interface 112 to display response 258 to the user of user system 110. Further details regarding sending the generated response to the user are discussed with reference to FIG. 2.

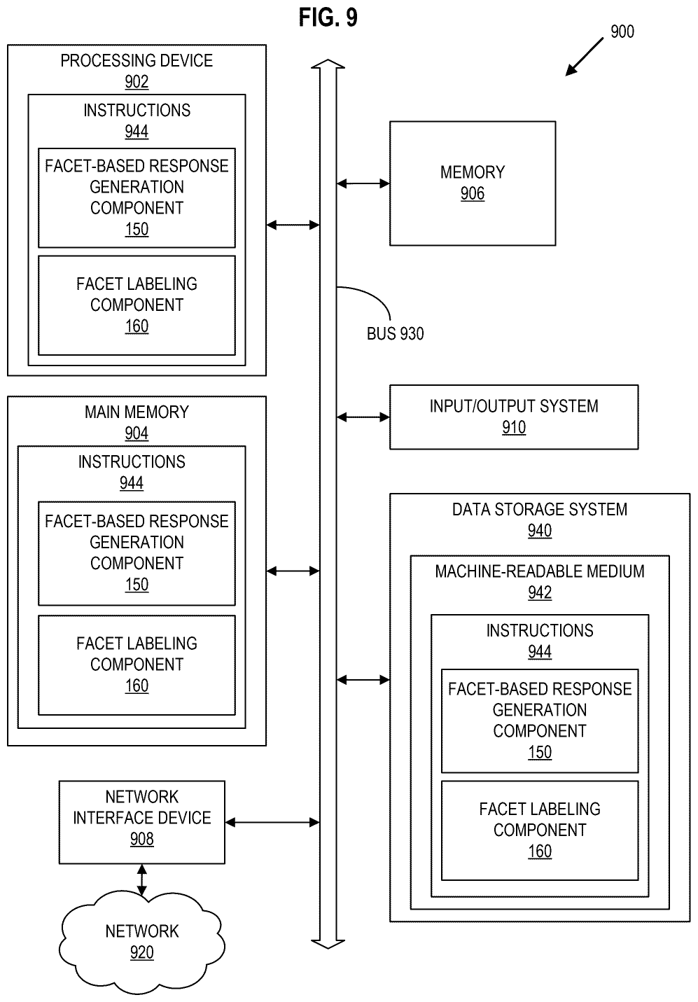

FIG. 9 illustrates an example machine of a computer system 900 within which a set of instructions for causing the machine to perform any one or more of the methodologies discussed herein, can be executed. In some embodiments, the computer system 900 can correspond to a component of a networked computer system (e.g., computing system 100 of FIG. 1) that includes, is coupled to, or utilizes a machine to execute an operating system to perform operations corresponding to facet-based response generation component 150 and/or facet labeling component 160 of FIG. 1. The machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random-access memory (DRAM) such as synchronous DRAM (SDRAM) or Rambus DRAM (RDRAM), etc.), a memory 906 (e.g., flash memory, static random-access memory (SRAM), etc.), an input/output system 910, and a data storage system 940, which communicate with each other via a bus 930.

Processing device 902 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 can also be one or more special-purpose processing devices such as an application specific integrated circuit (ASIC), a field programmable gate array (FPGA), a digital signal processor (DSP), network processor, or the like. The processing device 902 is configured to execute instructions 944 for performing the operations and steps discussed herein.

The computer system 900 can further include a network interface device 908 to communicate over the network 920. Network interface device 908 can provide a two-way data communication coupling to a network. For example, network interface device 908 can be an integrated-services digital network (ISDN) card, cable modem, satellite modem, or a modem to provide a data communication connection to a corresponding type of telephone line. As another example, network interface device 908 can be a local area network (LAN) card to provide a data communication connection to a compatible LAN. Wireless links can also be implemented. In any such implementation, network interface device 908 can send and receive electrical, electromagnetic or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic or optical signals that carry digital data to and from computer system computer system 900.

Computer system 900 can send messages and receive data, including program code, through the network(s) and network interface device 908. In the Internet example, a server can transmit a requested code for an application program through the Internet and network interface device 908. The received code can be executed by processing device 902 as it is received, and/or stored in data storage system 40, or other non-volatile storage for later execution.

The input/output system 910 can include an output device, such as a display, for example a liquid crystal display (LCD) or a touchscreen display, for displaying information to a computer user, or a speaker, a haptic device, or another form of output device. The input/output system 910 can include an input device, for example, alphanumeric keys and other keys configured for communicating information and command selections to processing device 902. An input device can, alternatively or in addition, include a cursor control, such as a mouse, a trackball, or cursor direction keys for communicating direction information and command selections to processing device 902 and for controlling cursor movement on a display. An input device can, alternatively or in addition, include a microphone, a sensor, or an array of sensors, for communicating sensed information to processing device 902. Sensed information can include voice commands, audio signals, geographic location information, and/or digital imagery, for example.

The data storage system 940 can include a machine-readable storage medium 942 (also known as a computer-readable medium) on which is stored one or more sets of instructions 944 or software embodying any one or more of the methodologies or functions described herein. The instructions 944 can also reside, completely or at least partially, within the main memory 904 and/or within the processing device 902 during execution thereof by the computer system 900, the main memory 904 and the processing device 902 also constituting machine-readable storage media.

In one embodiment, the instructions 944 include instructions to implement functionality corresponding to a facet-based response generation component (e.g., facet-based response generation component 150 of FIG. 1). In another embodiment, the instructions 944 include instructions to implement functionality corresponding to a facet labeling component (e.g., facet labeling component 160 of FIG. 1). In yet another embodiment, the instructions 944 include instructions to implement functionality corresponding to both a facet-based response generation component and a facet labeling component (e.g., facet-based response generation component 150 and facet labeling component 160 of FIG. 1). While the machine-readable storage medium 942 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100, can carry out the computer-implemented methods 500, 600, 700, and 800 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples or a combination of the described below.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving, from a user of an online system, input via a chat interface;
determining a set of facets for the input using data for the user of the online system;
generating an embedding for the input;
retrieving a plurality of content item embeddings, wherein each of the plurality of content item embeddings is labeled with one or more facets based on a content item associated with that content item embedding;
filtering the plurality of content item embeddings using the determined set of facets and the labeled one or more facets for each of the plurality of content item embeddings;
determining a set of relevant content items using the input embedding and the filtered plurality of content item embeddings;
generating a response prompt using the input embedding and the set of relevant content items;
generating a response by applying a generative machine learning model to the response prompt; and
sending the generated response, via the chat interface, to the user of the online system.

2. The method of claim 1, wherein determining the set of relevant content items comprises:
performing a similarity search using the input embedding and the filtered plurality of content item embeddings.

3. The method of claim 2, wherein determining the set of relevant content items further comprises:
determining that a content item of the relevant content items includes a chunk identifier;
identifying one or more additional content items using the chunk identifier; and
including the one or more additional content items in the set of relevant content items in response to identifying the one or more additional content items.

4. The method of claim 1, further comprising:
retrieving a plurality of content items, wherein each of the plurality of content items includes one or more tags;
filtering the plurality of content items using a set of rules;
generating the plurality of content item embeddings using the filtered plurality of content items; and
labeling each of the plurality of content item embeddings with the one or more facets using the one or more tags for an associated content item.

5. The method of claim 1, wherein determining the set of facets comprises:
retrieving user data for the user of the online system; and
determining the set of facets using the retrieved user data.

6. The method of claim 1, further comprising:
classifying an intent for the input, wherein generating the response prompt uses the classified intent.

7. The method of claim 6, wherein classifying the intent for the input comprises:
retrieving user data for the user of the online system, wherein classifying the intent uses the user data and the input.

8. The method of claim 1, wherein filtering the plurality of content item embeddings using the determined set of facets comprises:
determining content item embeddings of the plurality of content item embeddings that are associated with the determined set of facets; and
retrieving the determined content item embeddings.

9. The method of claim 1, wherein generating the response prompt using the input and the set of relevant content items comprises:
generating the response prompt instructing the generative machine learning model to respond to the input, wherein the response prompt includes links to the set of relevant content items for the generative machine learning model to reference.

10. The method of claim 1, further comprising:
dividing the generated response into a plurality of response subdivisions;
validating each of the plurality of response subdivisions; and
sending each of the plurality of response subdivisions, via the chat interface, to the user of the online system, in response to successfully validating that response subdivision.

11. A system comprising:
at least one memory device; and
a processing device, operatively coupled with the at least one memory device, to:
receive, from a user of an online system, at a chat interface, input;
determine a set of facets for the input, wherein the set of facets is based on data for the user of the online system;
generate an embedding for the input;
retrieve a plurality of content item embeddings, wherein each of the plurality of content item embeddings is labeled with one or more facets based on a content item associated with that content item embedding;
filter the plurality of content item embeddings using the determined set of facets and the labeled one or more facets for each of the plurality of content item embeddings;
determine a set of relevant content items using the input embedding and the filtered plurality of content item embeddings;
generate a response prompt using the input embedding and the set of relevant content items;
generate a response by applying a generative machine learning model to the response prompt; and
send the generated response, via the chat interface, to the user of the online system.

12. The system of claim 11, wherein determining the set of relevant content items comprises:
performing a similarity search using the input embedding and the filtered plurality of content item embeddings.

13. The system of claim 12, wherein determining the set of relevant content items further comprises:
determining that a content item of the relevant content items includes a chunk identifier;
identifying one or more additional content items using the chunk identifier; and
including the one or more additional content items in the set of relevant content items in response to identifying the one or more additional content items.

14. The system of claim 11, wherein determining the set of facets comprises:
retrieving user data for the user of the online system; and
determining the set of facets using the retrieved user data.

15. The system of claim 11, wherein the processing device is further to:
classify an intent for the input, wherein generating the response prompt uses the classified intent.

16. The system of claim 15, wherein classifying the intent for the input comprises:
retrieving user data for the user of the online system, wherein classifying the intent uses the user data and the input.

17. The system of claim 11, wherein filtering the plurality of content item embeddings using the determined set of facets comprises:
determining content item embeddings of the plurality of content item embeddings that are associated with the determined set of facets; and
retrieving the determined content item embeddings.

18. The system of claim 11, wherein generating the response prompt using the input and the set of relevant content items comprises:
generating the response prompt instructing the generative machine learning model to respond to the input, wherein the response prompt includes links to the set of relevant content items for the generative machine learning model to reference.

19. The system of claim 11, wherein the processing device is further to:
divide the generated response into a plurality of response subdivisions;
validate each of the plurality of response subdivisions; and
send each of the plurality of response subdivisions, via the chat interface, to the user of the online system, in response to successfully validating that response subdivision.

20. A system comprising:
at least one memory device; and
a processing device, operatively coupled with the at least one memory device, to:
receive, from a user of an online system, at a chat interface, input;
determine a set of facets for the input, wherein the set of facets is based on data for the user of the online system;
generate an embedding for the input;
retrieve a plurality of content items, wherein each of the plurality of content items includes one or more tags;
filter the plurality of content items using a set of rules;
generate a plurality of content item embeddings using the filtered plurality of content items;
label each of the plurality of content item embeddings with one or more facets using the one or more tags for an associated content item;
filter the plurality of content item embeddings using the determined set of facets;
determine a set of relevant content items using the input embedding and the filtered plurality of content item embeddings;
generate a response prompt using the input and the set of relevant content items;
generate a response by applying a generative machine learning model to the response prompt; and
send the generated response, via the chat interface, to the user of the online system.
